(19) United States
(12) Patent Application Publication
(10) Pub. No.: US 2001/0049088 A1
(43) Pub. Date: Dec. 6, 2001

(54) Education system using satellite communications

(75) Inventor: Osamu Ichiyoshi, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/871,650

(22) Filed: Jun. 4, 2001

(30) Foreign Application Priority Data
Jun. 2, 2000 (JP) 2000-166229

(51) Int. Cl. G09B 3/00; A63F 9/24

(52) U.S. Cl. 434/350; 463/40

(57) ABSTRACT

An education system using satellite communications, including a satellite communication correspondence school for providing an education service, which is connected to subscriber terminals operated by subscribers for receiving lectures via a satellite communication earth station and a communication satellite, and also via a communication network on the ground including the Internet so as to distribute lectures and associated educational materials to subscriber terminals for receiving signals from the communication satellite and to communicate questions and answers of subscribers in a broadcasting manner. The satellite communication correspondence school is also connected to lecturer terminals via the satellite communication earth station and the communication satellite and via communication network on the ground. A real time lecture is simultaneously carried out by the lecturers and subscribers using a broadcasting function of the communication satellite, a return communication function using either the ground communication network or the communication satellite, and a communication function for lectures. As a result, an interactive education system can be obtained without limiting the number of educational programs, and communication expense can be reduced.

### BACKGROUND OF THE INVENTION

The present invention relates to an education system using satellite communications for carrying out an education business which utilizes a broadcasting function provided by satellite communications.

Conventionally, a wide variety of education have been carried out using satellite communications. In a large country such as Australia, schools using a radio communication system have been open for many years for students living in distant places. In Japan, NHK (Japan broadcasting corporation) has provided through the second channel allocated to NHK various educational programs for a variety of viewing audience ranging from elementary school students to university students and the general public. Open university or university of the air using a television broadcasting has already given satisfactory results for more than ten years, and such university has become established among people. Furthermore, lectures and seminars are frequently given by using satellite communications which connect different universities. Preparatory schools for entrance examinations provide interconnection between distant classrooms and give examination guidance to students preparing for an examination.

Meanwhile, schools providing students with education at home using the Internet which has been well developed recently, have become very popular. FIG. 1 shows a conventional correspondence education system or a distance learning system including a correspondence school using the Internet. As shown in FIG. 1, the conventional correspondence education system comprises subscriber terminals 5 of subscribers who have registered to the correspondence school, lecturer terminals 6 used by lecturers of the correspondence school, the Internet 71, and home page 8 of the correspondence school.

Conventional correspondence education system described in FIG. 1 operates as follows. The lecturers prepare educational materials and enter them into the home page 8 of the correspondence school from the lecturer terminals 6. Subscribers gain access to the correspondence school's home page 8 from the subscriber terminals 5, via the Internet 71, and read desired educational materials out of the home page 8 to use them for learning. Subscribers also input questions, comments, and answers to lectures given by the lecturers, into the home page 8 of the correspondence school via the Internet. Lecturers then answer these questions, comments, and answers entered by the subscribers, in their next lecture or by using educational materials.

In this way, in the conventional correspondence education system, lecturers can prepare educational materials and subscribers can use these materials for learning, at their convenient time. If both lecturers and subscribers can connect or access to the Internet 71, it does not matter where they are. No temporal and spatial restrictions are placed on lecturers and subscribers, therefore the system gives them a high degree of freedom. At the same time, an interactive correspondence-education system adopting a two-way communication can be readily constructed. Educational materials include not only those made by characters or letters, but materials that use various forms of information such as pictures, images, voices, and the like. Such school using the Internet provides an epoch-making correspondence education system.

However, schools employing the Internet have the following problems. Firstly, it costs as far as a communication expense is concerned. This is because the Internet is originally a network for providing a point-to-point connection in a packet communication method. Even the number of subscriber terminals 5 is increased, it does not cut a communication expense for each subscriber terminal. Assuming that the amount of data required for one-hour lecture of a subject is 10 Mbytes, it takes 1600 seconds or about 30 minutes to read out the data through a line with a rate of 50 Kbps. Thus, a communication expense required for that length of time becomes a considerable one. If a subscriber (auditor) takes two subjects or courses a day, it takes about one hour only for reading out educational materials. If the number of subjects taken by the subscriber increases, time and expense required for communication also increase. This endangers performance of business.

Secondly, it is difficult to give a seminar of instantaneous type. As clearly understood from the aforementioned system, the Internet 71 is configured to store data in a regular manner in the home page 8 of the correspondence school which takes a leading part. Subscribers access via the Internet 71 the home page to read the necessary data when the need arises. For giving such seminar, it is necessary to establish a telephonic connection between the subscriber terminal 5 and lecturer terminal 6. However, this becomes extremely difficult when the number of subscriber terminals 5 increases.

The conventional education system has following problems to be solved. Firstly, quantitative restrictions are placed on provided programs due to a communication capacity. For instance, NHK regularly broadcasts through its second channel different educational programs every fifteen minutes as a radio program, which enables to broadcast only four subjects an hour. With respect to the open university, only one TV channel is allocated to it, the capacity is therefore considerably restricted. On the other hand, students of a school that utilizes the Internet can access to its home page, by which a plurality of subjects are simultaneously provided to the students. Even in this case, there is a limit to the information amount owing to communication capacity. Communication expense therefore rises as the information amount increases.

Secondly, communication charge is expensive. In this regard, the above-described education system using a broadcasting has no particular problem, however it is a fundamental problem for schools using the Internet. As mentioned above, the Internet provides a point-to-point connection, and has insufficient broadcasting function. Radio or TV broadcasting has no limit in the number of listeners or viewers, where the whole cost required for broadcasting is independent of that number. Accordingly, communication expense per person will decrease as TV viewers increase. However, communication expense required to use the Internet increases in proportion to its utilization, in which per capita expense with regard to subscribers has no relationship to the number of users. The Internet provides no cost reduction as that obtained by the broadcasting system. With the increase of subscribers, it is inevitable that communication lines are congested, which causes a line connection failure, delay in response time, and the like.

Thirdly, it is difficult to conduct an interactive education. Radio or TV education system as mentioned above is by nature one-way education system, because it broadcasts educational programs previously programmed and stored in a broadcasting station, in accordance with a predetermined program schedule. Schools using the Internet adopt a system in which subscribers read prepared information out of a home page via a communication line. This system is also an one-way communication system. In these schools, if subscribers can enter their correspondence in a home page, a certain degree of dialogue is possible. In the education using a broadcasting, questions and suggestions of listeners or viewers sent by mail or facsimile are accepted, which are placed in a monthly text. However, this method is far from an interactive system.

### SUMMARY OF THE INVENTION

The present invention has been made in view of the aforementioned problems of prior art. It is an object of the present invention to provide an education system capable of providing a large number of subjects for an extremely large number of subscriber terminals at a low cost, and readily carrying out an interactive education.

In accordance with one aspect of the present invention, there is provided an education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, whereby said satellite communication correspondence school provides said subscribers with said lectures and associated educational materials in a broadcasting manner.

In the present invention, in order to provide a return communication function to said subscribers having subscriber terminals with a transmission function with respect to said communication satellite, said satellite communication earth station has a satellite communication function for receiving signals sent from said subscribers via said communication satellite, and a transfer function for transferring said received signals to said satellite communication correspondence school.

The satellite communication correspondence school according to the present invention provides said lecturers with a material preparing means for making up educational materials using figures, pictures, images, compositions, and voices, receives said educational materials made by said lecturers with the help of a communication function dedicated to lecturers for accessing to a mailbox and e-mails, performs data compression on said received educational materials, temporarily stores said compressed data, and sends said educational materials to said satellite communication earth station in accordance with a predetermined time schedule, and wherein said satellite communication earth station provides said subscriber terminals with said educational materials via said communication satellite in a broadcasting manner.

In accordance with another aspect of the present invention, there is provided an education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said satellite communication correspondence school being connected to said lecturer terminals for lecturer's use via said satellite communication earth station and communication satellite, and via said communication network on the ground, whereby a real time lecture function is provided for giving a seminar in which said lecturers and subscribers simultaneously use a broadcasting function of said communication satellite, a return communication function using either said communication network on the ground or said communication satellite, and a communication function for lectures for accessing to a mailbox equipped in said satellite communication correspondence school and to e-mails.

In accordance with another aspect of the present invention, there is provided an education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said subscriber terminals being used for a direct satellite broadcast (DSB) receiver and a very small aperture terminal (VSAT), whereby said satellite communication correspondence school provides said subscribers with said lectures and associated educational materials in a broadcasting manner.

In accordance with another aspect of the present invention, there is provided an education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein if said communication satellite radiates global beams and spot beams, said satellite communication earth station being arranged within said global beams, and said subscriber terminals being arranged within said spot beams, whereby said satellite communication correspondence school provides said subscribers with said lectures and their associated educational materials in a broadcasting manner.

In accordance with another aspect of the present invention, there is provided an education system using satellite communications comprising a satellite communication correspondence school which is plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein if said communication satellite radiates a plurality of spot beams, said satellite communication earth station being arranged within part of said spot beams, and said subscriber terminals being arranged within remaining spot beams within which no earth station is arranged, whereby said satellite communication correspondence school provides said subscribers with said lectures and their associated educational materials in a broadcasting manner.

Furthermore, in accordance with another aspect of the present invention, there is provided an education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said subscriber terminals being realized by portable satellite communication terminals, whereby said satellite communication correspondence school provides said subscribers with said lectures and associated educational materials in a broadcasting manner.

### BRIEF DESCRIPTION OF THE DRAWINGS

The objects, features and advantages of the present invention will become more apparent from the consideration of the following detailed description, taken in conjunction with the accompanying drawings, in which:

FIG. 1 is a schematic diagram showing a conventional correspondence education system including a correspondence school using the Internet;

FIG. 2 is a schematic diagram showing an education system using satellite communications according to an embodiment of the present invention;

FIG. 3 is a block diagram of a receive-only satellite communication subscriber terminal;

FIG. 4 is a block diagram of a two-way satellite communication subscriber terminal;

FIG. 5 is a block diagram of a satellite communication earth station and a satellite communication correspondence school;

FIG. 6 is a sequential diagram with respect to lectures and associated communications between lecturer terminals and subscriber terminals;

FIG. 7A is a diagram showing a GB/SB system; and

FIG. 7B depicts an SB/SB system.

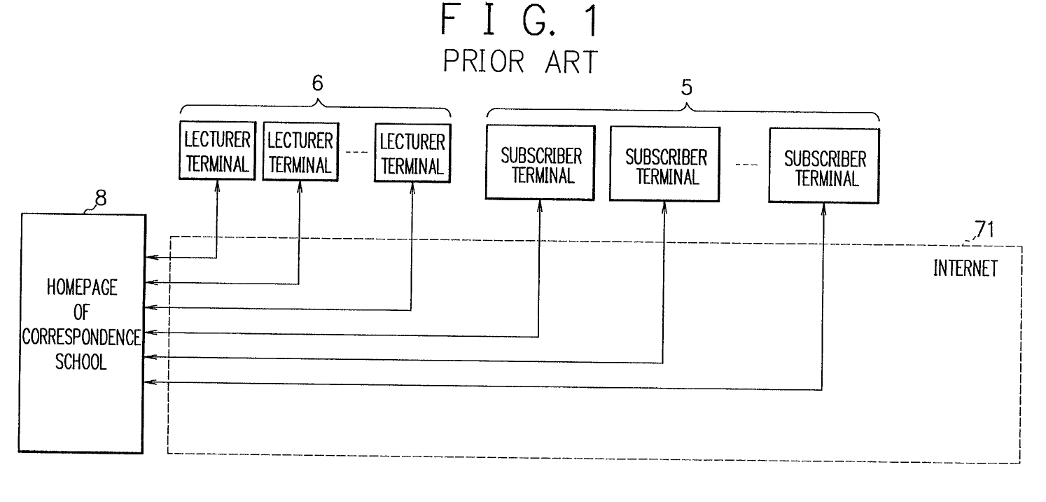

### DESCRIPTION OF THE PREFERRED EMBODIMENTS

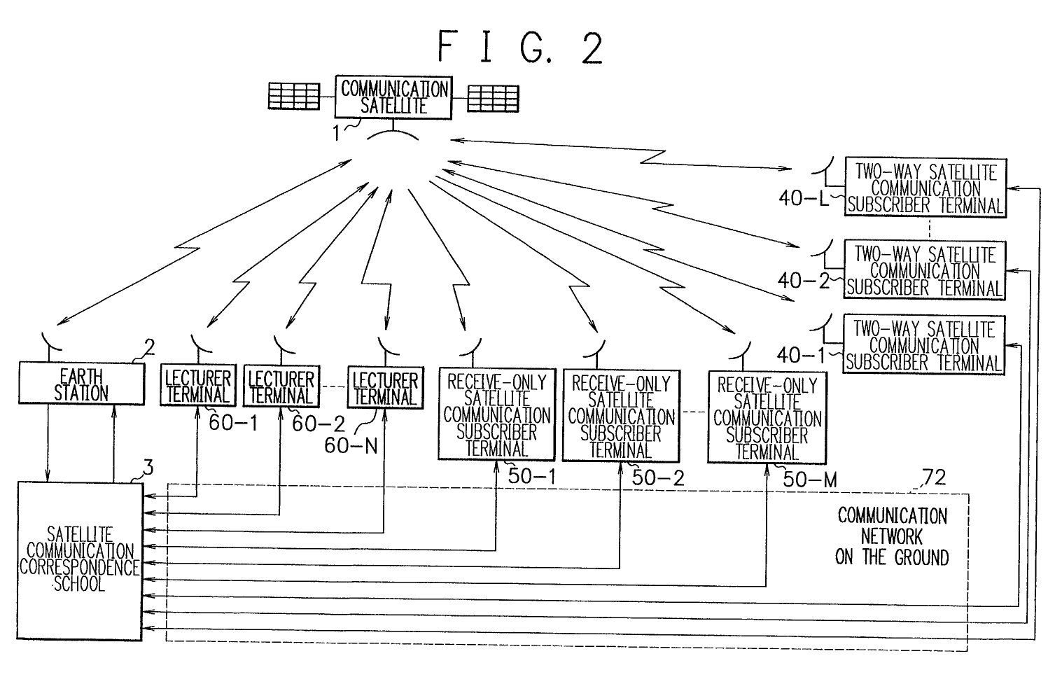

Referring now to the drawings, description will be given of embodiments according to the present invention. FIG. 2 shows a configuration of an education system using satellite communications according to an embodiment of the present invention. As shown in FIG. 2, an education system comprises a communication satellite 1, a satellite communication earth station 2 for sending and receiving signals, a satellite communication correspondence school (a satellite communication distance-learning school) 3 for providing education for subscribers who take lectures, a plurality of two-way satellite communication subscriber terminals 40-1 to 40-L (L is a positive integer) for receiving and sending signals to and from the satellite communication earth station 2 via the communication satellite 1. The system also comprises a plurality of receive-only satellite communication subscriber terminals 50-1 to 50-M (M is a positive integer) for only receiving signals from the communication satellite 1, a plurality of lecturer terminals 60-1 to 60-N (N is a positive integer) used by lecturers who are working at the satellite communication correspondence school 3, and a communication network 72 on the ground including a telephone network, facsimile communication network, e-mail communication network, and the like.

Lecturers give lectures to the subscribers using their lecturer terminals 60-1 to 60-N. Details of lectures and educational materials are sent to the subscribers from the satellite communication correspondence school 3 to the communication satellite 1 via the earth station 2 in a broadcasting manner. Subscribers then take lectures using the two-way satellite communication subscriber terminals 40-1 to 40-L and the receive-only satellite communication subscriber terminals 50-1 to 50-M.

As shown in FIG. 2, the satellite communication correspondence school 3 carries out satellite communications with the two-way satellite communication subscriber terminals 40-1 to 40-L and the receive-only satellite communication subscriber terminals 50-1 to 50-M, via the earth station 2 and the communication satellite 1. To communicate with the terminals 40-1 to 40-L or terminals 50-1 to 50-M, the satellite communication correspondence school 3 performs a mailbox function or a return-communication function for e-mails, where information associated with telephone calls and facsimile signals is temporarily stored which have been received via a return communication line using the communication satellite 1 or communication network 72 on the ground. That is, the satellite communication correspondence school 3 has a ground communication function using the communication network 72 on the ground.

The satellite communication correspondence school 3 can also communicate with the lecturer terminals 60-1 to 60-N, via the satellite communication earth station 2 and the communication satellite 1, or via the communication network 72. Terminals and their associated routes as mentioned above are the main portion of the education system according to the present invention.

The communication network 72 on the ground used for lecturers will be described below. As apparent from the aforementioned system configuration, in the education system of the present invention, it is enough for the lecturer terminals 60-1 to 60-N to be coupled with the satellite communication correspondence school 3 via the communication network 72 on the ground, so as to perform necessary communication. Therefore, lecturers including those who are living in distant places do not necessarily work in the satellite communication correspondence school 3. The satellite communication correspondence school 3 enables the lecturers to access mailbox and e-mail functions provided by the satellite communication correspondence school 3, which is a communication function given to the lecturers.

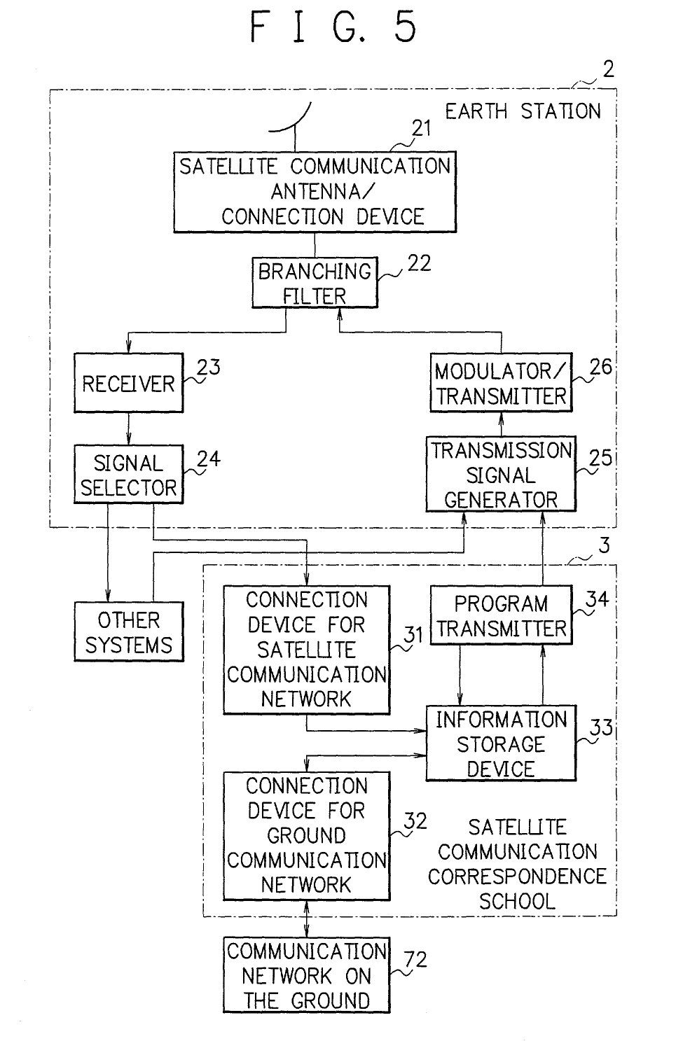

Two-way satellite communication subscriber terminals 40-1 to 40-L may act as the lecturer terminals 60-1 to 60-N. The satellite communication correspondence school 3 provides the lecturers with a means for processing signals for preparing educational materials, which include a means for producing, recording and reproducing figures, pictures, images, compositions and voices, a means for compressing data, and the like. Educational materials prepared by the lecturers are then sent to the satellite communication correspondence school 3 via the communication network 72 on the ground, or via the communication satellite 1. The education system of the present invention can therefore provide the lecturers as well as the subscribers who are students taking lectures, with temporal and spatial freedom. The educational materials are subjected to data compression and stored in an information storage device 33 (see FIG. 5) of the satellite communication correspondence school 3. The educational materials stored in the information storage device are sent from the satellite communication correspondence school 3 to the satellite communication earth station 2. Materials are then broadcast from the satellite communication station 2 via the communication satellite 1 in accordance with a predeterminate time schedule.

It should be noted that an identification (ID)/pass word may be prepared and registered for lecturers and subscribers who are requested to exhibit their ID when they visit or use the satellite communication correspondence school 3. This results in improvement in safety.

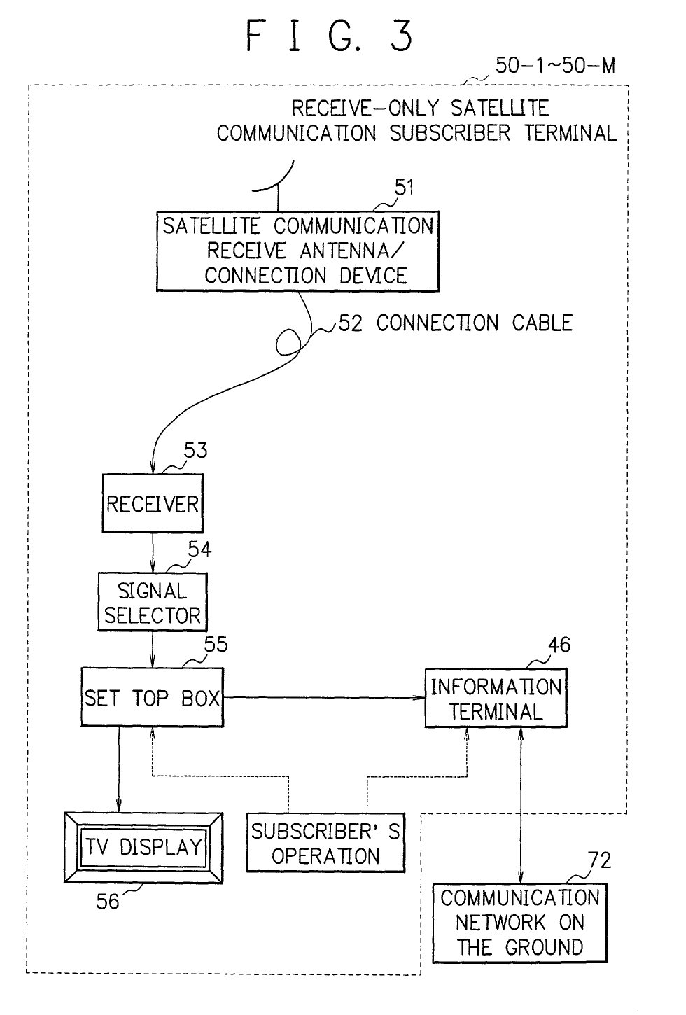

FIG. 3 illustrates a construction of receive-only satellite communication subscriber terminals 50-1 to 50-M shown in FIG. 2, which can also be used as a satellite broadcast receiver or a direct satellite broadcast (DSB) receiver. As shown in FIG. 3, the receive-only satellite communication subscriber terminal includes a satellite communication receiving antenna (satellite dish)/connection device 51, a connection cable 52, a receiver 53 for carrying out amplification and demodulation for received signals, a signal selector 54 for selecting a signal directed to the subscriber from among the received signals, a set top box (STB) 55 having a memory for storing the selected signal and reproducing an image and voice associated with the selected signal in accordance with subscriber's operation, a TV display 56 for displaying an image upon reception of the signal sent from the STB 55, and an information terminal 46 such as a personal computer (PC) connected to the communication network 72 on the ground.

The receive-only satellite communication subscriber terminal 50 shown in FIG. 3 can be made by using a commercially available DSB receiver without modifying it. In such case, the satellite communication receiving antenna/connection device 51 is generally installed out of the house, while other parts are installed in doors. STB 55 and TV display 56 can operate as a receiver/display device for a conventional satellite broadcasting by subscriber's operation. Furthermore, STB 55 and display 56 are capable of operating as a subscriber terminal (two-way satellite communication subscriber terminals 40-1 to 40-L and receive-only satellite communication subscriber terminals 50-1 to 50-M) of the education system according to the present invention.

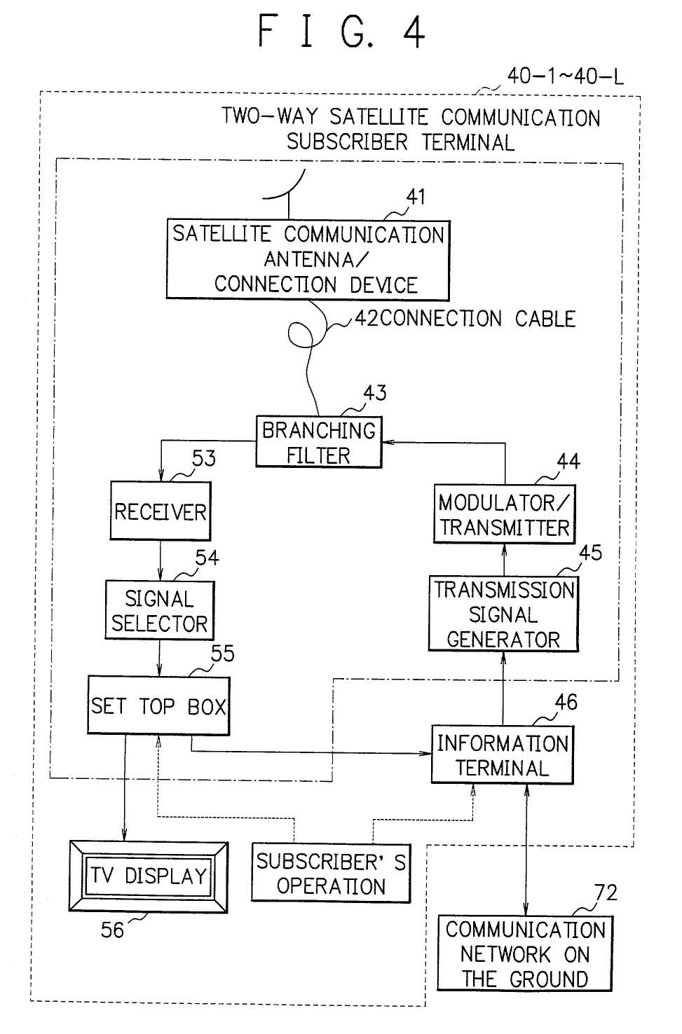

FIG. 4 shows a construction of two-way satellite communication subscriber terminals 40-1 to 40-L shown in FIG. 2, which can also be used as a very small aperture terminal (VSAT) or very small satellite communication earth station. Terminals 40-1 to 40-L can also be used lo as a direct satellite broadcast (DSB) receiver. Two-way satellite communication subscriber terminal includes as shown in FIG. 4 a satellite communication antenna/connection device 41 for receiving and transmitting signals, a connection cable 42, a branching filter 43 for separating sending signals from receiving signals, a modulator/transmitter 44, a transmission signal generator 45, an information terminal 46 such as a personal computer (PC) connected to the communication network 72 on the ground, a receiver 53 for carrying out amplification and demodulation for received signals, a signal selector 54 for selecting signals destined for the subscriber from among the received signals, a set top box (STB) 55 having a memory for storing the selected signal and for reproducing an image and voice associated with the selected signal in accordance with subscriber's operation, and a TV display 56 for displaying an image upon reception of the signal sent from the STB 55.

In the two-way satellite communication subscriber terminal 40, a signal generated by the information terminal 46 is sent to the transmission signal generator 45 where the signal is converted into a signal with a predetermined transmission form. The modulator/transmitter 44 performs a predetermined modulation, a frequency setup, and amplification on the transmission signal. The resultant signal is sent to the satellite communication antenna/connection device 41, via the branching filter 43 and the connection cable 42, from which the signal is transmitted in the air. The information terminal 46 is connected to the satellite communication correspondence school 3 via the communication network 72 on the ground.

Signal received by the satellite communication antenna/connection device 41 is sent to the branching filter 43 via the connection cable 42, and then sent from the branching filter 43 to the receiver 53 and the signal selector 54 where the signal is subjected to selection so as to obtain a signal directed to the subscriber. Subscriber operates the STB 55 to display an image on the TV display 56. More specifically, lectures and educational materials provided by the satellite communication correspondence school 3 in a broadcasting manner are stored in the STB 55 having a memory. Subscribers read stored lectures and educational materials out of the STB 55 and reproduce it when they use for their learning.

As clearly understood by comparing construction of the two-way satellite communication subscriber terminal as shown in FIG. 4 with that of the receive-only satellite communication subscriber terminal as shown in FIG. 3, the receiving section can also be used as a direct satellite broadcasting (DSB) receiver, and the transmission section can also be used as a VSAT terminal.

Storage of Ingredients of Lecture:

Storage of ingredients of lecture using a data storage technique will be described below. Digital signal processing that is currently available is not limited to a data compression. Another important advantage that a digital signal processing brings about is a temporary storage effect. In the present system, educational programs are continuously broadcast using the communication satellite 1. The signal selector 54 of the two-way satellite communication subscriber terminals 40-1 to 40-L and receive-only satellite communication subscriber terminals 50-1 to 50-M selectively receives signals addressed to the subscriber at a predetermined time. The STB 55 stores the received signals in its memory. Subscribers read the stored ingredients of lecture out of the memory for their use at their convenient time. Temporary storage effect makes it possible to provide ingredients of lecture to thousands of subscribers using unoccupied hours late at night. In this manner, subscribers having various jobs and living in a broad area are provided with educational programs without any constraint both temporally and locally.

Distribution of Educational Materials:

Distribution of educational materials will be described below. Educational materials (ingredients of subjects) used for giving lectures are distributed utilizing a broadcasting function that the communication satellite 1 has. As described above, the two-way satellite communication subscriber terminals 40-1 to 40-L and receive-only satellite communication subscriber terminals 50-1 to 50-M can be used for DSB receivers, therefore the system becomes inexpensive. Maintenance cost also becomes inexpensive because distribution of educational materials is conducted late at night when many broadcasting channels are unused. Utility rate for a satellite channel of about 10 Mbps is say, 20000 yen per hour. If 10-Megabyte educational materials as described above are distributed by using this broadcasting channel, it takes about 10 seconds, costing less than 100 yen. When 100 subscribers enjoy distribution of such educational materials, a distribution cost per person becomes less than 1 yen. With this broadcasting channel, the number of subjects that can be distributed in an hour is more than 300. Thousands of educational materials can be then distributed in late-night hours. Compared with subjects provided by the present open university, the number of subjects according to the present invention can be multiplied hundreds of times.

FIG. 5 shows a construction of the satellite communication earth station 2 and satellite communication correspondence school 3, which are an essential part of the present invention system. The earth station 2 has a satellite communication function for receiving signals sent from subscribers via the communication satellite 1, and a transfer function for transferring the received signals to the satellite communication correspondence school 3. Satellite communication antenna/connection device 21 of the earth station 2 receives and transmits signals to and from the communication satellite 1. Branching filter 22 separates transmission signals from received signals, where the received signals are sent to a receiver 23 for carrying out amplification and demodulation, and the transmission signals to the satellite communication antenna/connection device 21. Signal selector 24 receives signals from the receiver 23, selects from among the received signals a signal directed to a subscriber, and sends the selected signal to other systems or to a connection device 31 for a satellite communication network. Transmission signal generator 25 generates transmission signals in accordance with information sent from a program transmitter 34. Signals thus generated are sent to a modulator/transmitter 26.

Connection device 31 for a satellite communication network arranged in the satellite communication correspondence school 3 receives signals from the signal selector 24 of the earth station 2, and sends them to an information storage device 33. This device 33 temporarily stores communication information associated with the communication satellite 1 or the communication network 72 on the ground. Connection device 32 for a ground communication network performs transmission/reception connection with the communication network 72 on the ground. The program transmitter 34 reads information out of the information storage device 33 according to a predetermined time schedule, and converts the read-out information into information with a broadcasting form. The converted information is sent to the transmission signal generator 25 of the satellite communication earth station 2.

Sequences with Respect to Lectures and the Like:

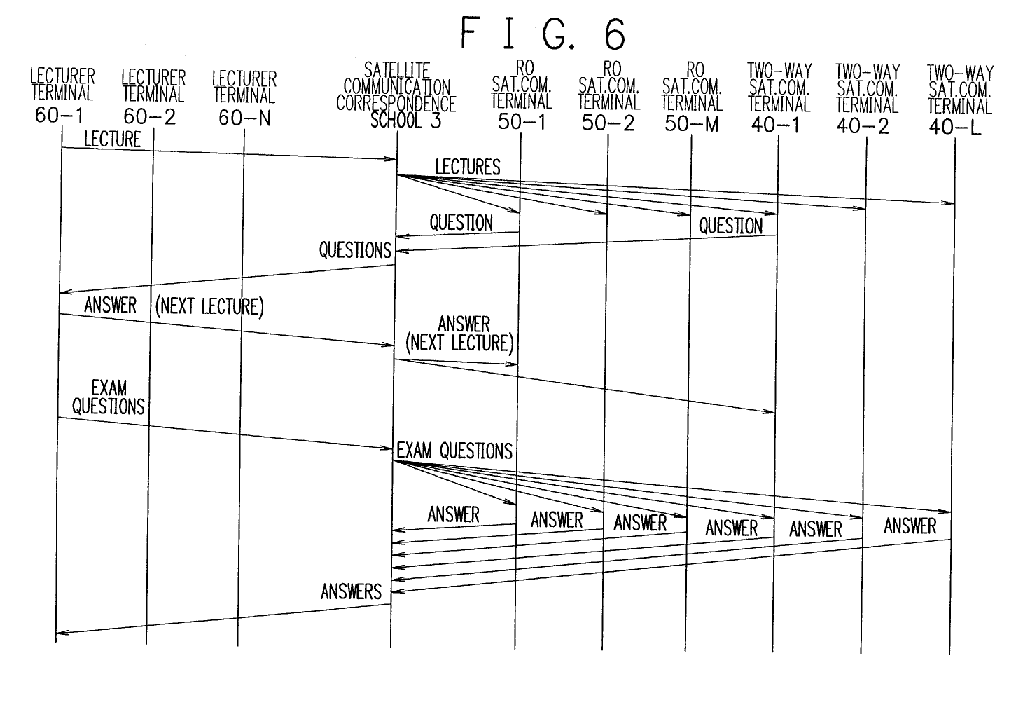

FIG. 6 is a sequential diagram with respect to lectures and their associated communication performed among lecturer terminals 60-1 to 60-N, receive-only (RO) satellite communication subscriber terminals 50-1 to 10-M, and two-way satellite communication subscriber terminals 40-1 to 40-L. Distribution and communication of lectures, questions, answers to the questions, examination questions, answers to the examination questions, and so on conducted in the education system of the present invention will be described with reference to FIG. 6. The education system according to the present invention can readily provide a conversational or interactive function which is essential to education.

In the system as shown in FIG. 6, a lecturer sends data or information associated with his/her lecture to the satellite communication correspondence school 3 using a lecturer terminal 60-1. The satellite communication correspondence school 3 transfers the “lecture” to the receive-only satellite communication subscriber terminals 50-1 to 50-M, and to the two-way satellite communication subscriber terminals 40-1 to 40-L, via the communication satellite 1 in a broadcasting manner. Questions with respect to the lecture are sent by way of example from the receive-only satellite communication subscriber terminal 50-1 and from the two-way satellite communication subscriber terminal 40-1, to the satellite communication correspondence school 3 via the communication network 72 on the ground. The satellite communication correspondence school 3 then transfers the questions in block to the lecturer terminal 60-1. When the lecturer gives the next lecture, he/she sends answers to the questions to the satellite communication correspondence school 3 using the lecturer terminal 60-1. The satellite communication correspondence school 3 sorts the answers, and transfers respective one to the receive-only satellite communication subscriber terminal 50-1 and the two-way satellite communication subscriber terminal 40-1.

Examination questions prepared by the lecturer are also sent to is the satellite communication correspondence school 3 using the lecturer terminal 60-1 in the same manner as the lecture. The satellite communication correspondence school 3 transfers the examination questions to the receive-only satellite communication subscriber terminals 50-1 to 50-M, and to the two-way satellite communication subscriber terminals 40-1 to 40-L via the communication satellite 1 in a broadcasting manner. Subscribers send back answers to the examination questions, from the receive-only satellite communication subscriber terminals 50-1 to 50-M and the two-way satellite communication subscriber terminals 40-1 to 40-L to the satellite communication correspondence school 3. The satellite communication correspondence school 3 then transfers these questions in block to the lecturer terminal 60-1.

As described above, subscribers can send questions, answers, and the like to the satellite communication correspondence school 3 using the communication network 72 on the ground, such as a telephone network, a facsimile communication network, an e-mail communication network, and the like, without any constraint both temporally and locally.

If a sensitive system such as a multi-spot beam satellite communication system is equipped in the two-way satellite communication subscriber terminal 40-1, information from subscribers is sent to the earth station 2 via the communication satellite 1, from which the information is transferred to the lecturer terminal 60-1 via the satellite communication correspondence school 3. According to the present invention as described above, a return communication function using a variety of interactive lines such as lines on the ground through the communication network 72 on the ground, satellite communication lines via the communication satellite 1, and the like, provides an effective education system. 15

Seminars:

Seminars adopting the education system of the present invention will be described. In the education system of the present invention, with the use of an instantaneous method as well as a storage method, lecturers and subscribers can give a seminar simultaneously which utilizes the lecturer terminals 60-1 to 60-N, the receive-only satellite communication subscriber terminals 50-1 to 50-M, and the two-way satellite communication subscriber terminals 40-1 to 40-L. This corresponds to an immediate read-out of data stored in the information storage device 33 arranged in the satellite communication correspondence school 3, thus capable of being realized from the view point of signal processing by using the storage method as is.

Subscribers who are participating in a seminar and having the receive-only satellite communication subscriber terminals 50-1 to 50-M and the two-way satellite communication subscriber terminals 40-1 to 40-L, are continuously informed of information sent from the lecturer terminals 60-1 to 60-N during the seminar. Answers, questions, comments, and the like from the subscribers are transferred to the lecturer terminals 60-1 to 60-N via the satellite communication correspondence school 3. Lecturers immediately respond to all subscribers being connected. If many subscribers respond simultaneously, there will be a collision. However, a collision can be avoided if the lecturers manage the seminar by giving specific subscribers the right to speak. In particular, responses from subscribers who own the two-way satellite communication subscriber terminals 40-1 to 40-L are directly transferred to the lecturer terminals 60-1 to 60-N via the communication satellite 1, the earth station 2, and the satellite communication correspondence school 3. This enables an effective seminar of instantaneous type.

Accordingly, the education system of the present invention realizes a real-time lecture in which both lecturers and subscribers use a broadcasting function provided by the communication satellite 1, a return communication function using satellite communication lines given by the communication network 72 on the ground or by the communication satellite 1, and a communication function for lecturers.

Application to GB/SB and SB/SB Systems:

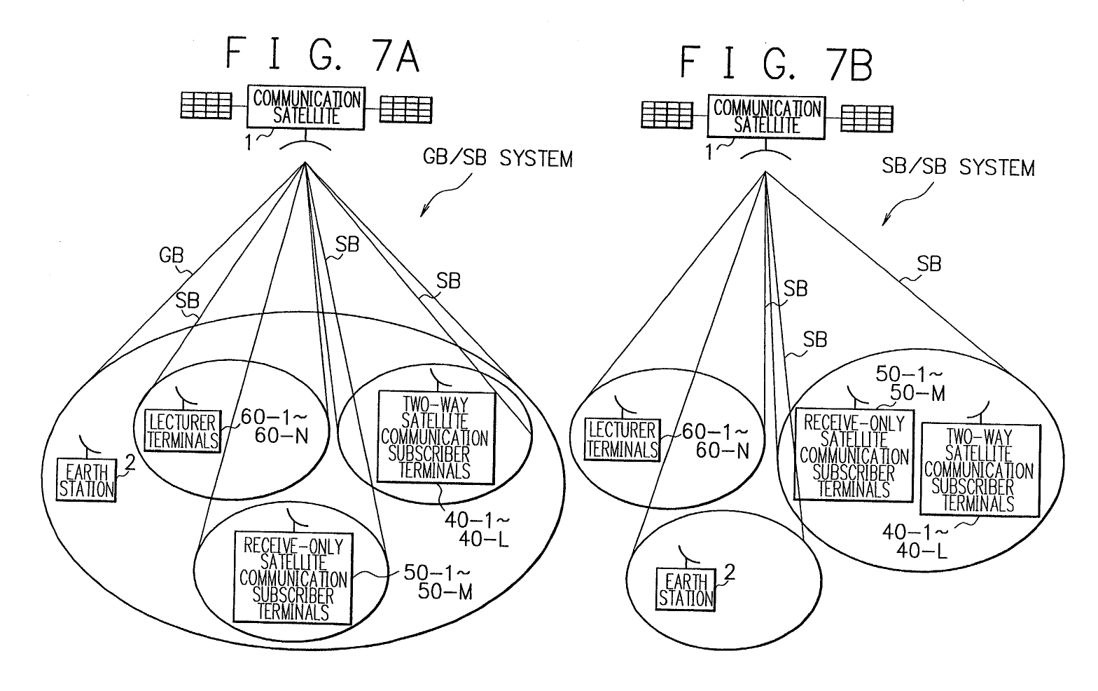

FIG. 7A schematically shows a GB/SB system, and FIG. 7B illustrates an SB/SB system, to which the education system according to the present invention is applied. In a GB/SB system as shown in FIG. 7A, a satellite communication earth station 2 is arranged in a GB (global beams) area defined by coverage of beams radiated from the communication satellite 1 (excluding SB (spot beams) areas defined by coverage of beams radiated from the communication satellite 1), while two-way satellite communication subscriber terminals 40-1 to 40-L, receive-only satellite communication subscriber terminals 50-1 to 50-M, and lecturer terminals 60-1 to 60-N are arranged in respective three SB areas within the GB area. In an SB/SB system as shown in FIG. 7B, a satellite communication earth station 2, two-way satellite communication subscriber terminals 40-1 to 40-L and receive-only satellite communication subscriber terminals 50-1 to 50-M, and lecturer terminals 60-1 to 60-N are arranged within respective SB areas.

It is known that in a satellite communication, a single communication satellite is capable of providing a communication network in a vast area such as ⅓ of earth's surface. One of distinctive features of forward communication lines (from satellite to ground) associated with a satellite communication is a broadcasting function in addition to a wide-area coverage. Satellite communication is particularly suitable to a broadcasting, which is now commercially available as a direct satellite broadcast (DSB). With respect to features of backward communication lines (from ground to satellite) associated with a satellite communication, it is provided a wide-area coverage. However, contrary to the feature, there exists a large attenuation of signals. The satellite communication earth station 2 therefore requires large-scale facilities comprising antenna of large diameter and a high-power transmitter to receive signals from the communication satellite 1, which gets rid of a broadcasting function. Furthermore, because of limited transmission power provided by the two-way satellite communication subscriber terminals 40-1 to 40-L, backward communication lines are in many cases restricted to a low rate communication. Conventional satellite communication system is an asymmetrical system which comprises the satellite communication earth station 2 that realizes a trunk line provided with a small number of large-scale facilities, and which is also composed of subscriber facilities having a large number of small-size satellite communication terminals. VSAT system is a typical example of an asymmetrical system. DSB system is far more asymmetrical.

However, in recent years, the communication satellite 1 can have on board antenna of large diameter for covering earth's surface using a large number of spot beams. As a result, receiving sensitivity of the communication satellite 1 has been greatly improved, therefore a considerably high rate communication can be performed from subscriber's small-size satellite communication terminals. The system of this kind is called a multi-spot beam satellite communication system.

Similar to the conventional system, many of the multi-spot beam satellite communication systems currently used adopt global beams for the main line or trunk line between the earth station 2 and the communication satellite 1. This requires the main line to have the satellite communication earth station 2 of the same scale as the conventional system. Satellite communication system in this stage is referred to as a GB/SB system. It is estimated that as far as a satellite communication system, transition is made in the next stage to an SB/SB system using spot beams for the main line. As shown in FIG. 7, the education system of the present invention can be applied to the GB/SB system and to the SB/SB system.

Increase in the Number of Lectures and Subjects:

As shown in FIG. 2, the satellite communication correspondence school 3 distributes ingredients of lectures and educational materials to which a multimedia technique is applied, by using an information processing technique. Distribution of this kind extremely increases the number of lectures and subjects for the satellite communication correspondence school 3.

Existing open university uses only one TV channel. This is not enough for full-fledged education, and usable frequency source is limited. Therefore, assignment of more channels cannot be expected. However, if ingredients of lectures are well examined, it is found that lectures as many times of existing ones can be broadcast by using the current TV frequency band. With the use of a present signal processing technique such as image compression and voice compression, a necessary bandwidth may be largely reduced. For example, for voice, it can be reduced to 8 Kbps, and for motion picture, to 300 Kbps. For high quality voice, 128 Kbps are enough to obtain sound quality with a degree of Compact Disk.

Ordinary lectures do not necessarily use motion pictures on a steady basis. Lecturer's voice should be heard all the time, however Is still pictures are basically enough to reproduce what a lecturer writes on the blackboard. High quality sound is essential to music, which is not always necessary. Though it depends upon ingredients of lectures, lectures usually require a rate raging from 128 Kbps to 256 Kbps on the average. Existing TV uses a bandwidth of approximately 5 MHz, which enables to broadcast 20 to 100 lectures. Assuming that 50 subjects are simultaneously broadcast, 1200 lectures can be broadcast in a day.

Education system using a satellite communication according to another embodiment of the present invention will now be described. In the two-way satellite communication subscriber terminals 40-1 to 40-L shown in FIG. 4, components in the area with a reference numeral 400 can be integrated. This integration can be realized by using a portable satellite communication terminal.

Geostationary satellite system radiating more than 200 spot beams has been developed. Such system is capable of performing a high-speed communication with a rate of several Mbps using a portable satellite communication terminal about the size of a laptop personal computer. Therefore, in addition to existing direct satellite broadcast (DSB) receiver and the VSAT terminal, a portable satellite communication terminal can be used for the education system of the present invention, which will be improved and developed with the future progress of technology.

As described above, according to the present invention, an education system with an extremely simple construction can be realized which covers a wide area without temporal and local constraints. This is because the present invention education system can use existing DSB receivers which makes the system construction easy and less expensive. Storage method employed in the present invention education system also brings about high degree of temporal freedom.

It is possible for the education system according to the present invention to realize a large-scale satellite communication correspondence school which exceeds in size any conventional educational institution. This comes from the number of subjects, thousands of subjects, that the present invention education system can provide in a day.

It is also possible for the education system of the present invention to give a seminar of instantaneous type as required. This is because all subscribers can participate in lectures at substantially the same time by utilizing a broadcasting function provided by satellite communications.

The education system according to the present invention can produce a social improvement. The reason is as follows. Conventional educational institution is restricted in its acceptable student capacity due to its facilities, for which an entrance examination is held for rejecting candidates. As a result, various distortions arise in school education. On the contrary, the satellite communication correspondence school associated with an education system using satellite communications, according to the present invention, has no limitation in the acceptable student or subscriber capacity. Any student who is eager to learn can enter the school. According to the present invention education system, students can study freely without any constraint temporally and locally, therefore education expense can be largely reduced. It is also possible to give a seminar of instantaneous type if necessary. Furthermore, when direct guidance is necessary, schooling employed in the conventional open university can be combined.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, whereby said satellite communication correspondence school provides said subscribers with said lectures and associated educational materials in a broadcasting manner.

2. An education system using satellite communications according to claim 1, wherein said satellite communication correspondence school has a return communication function to receive questions, answers, and answers to examination questions sent from said subscribers.

3. An education system using satellite communications according to claim 2, wherein said return communication function includes a ground communication function using said communication network on the ground, for the use of said subscribers having subscriber terminals which lack a transmission function with respect to said communication satellite.

4. An education system using satellite communications according to claim 2, wherein in order to provide a return communication function to said subscribers having subscriber terminals with a transmission function with respect to said communication satellite, said satellite communication earth station has a satellite communication function for receiving signals sent from said subscribers via said communication satellite, and a transfer function for transferring said received signals to said satellite communication correspondence school.

5. An education system using satellite communications according to claim 3, wherein said satellite communication correspondence school has a mailbox function and an e-mail communication function, for temporarily storing telephone signals and facsimile signals received with the help of said return communication function using said communication network on the ground.

6. An education system using satellite communications according to claim 4, wherein said satellite communication correspondence school has a mailbox function and an e-mail communication function, for temporarily storing telephone signals and facsimile signals received with the help of said return communication function using said communication satellite.

7. An education system using satellite communications according to claim 1, wherein said satellite communication correspondence school provides said lecturers including those who are living in distant places with a communication function dedicated to lecturers so that said lecturers access to a mailbox equipped in said satellite communication correspondence school and to e-mails.

8. An education system using satellite communications according to claim 1, wherein said satellite communication correspondence school provides said lecturers with a material preparing means for making up educational materials using figures, pictures, images, compositions, and voices, receives said educational materials made by said lecturers with the help of a communication function dedicated to lecturers for accessing to a mailbox and e-mails, performs data compression on said received educational materials, temporarily stores said compressed data, and sends said educational materials to said satellite communication earth station in accordance with a predetermined time schedule, and wherein said satellite communication earth station provides said subscriber terminals with said educational materials via said communication satellite in a broadcasting manner.

9. An education system using satellite communications according to claim 1, wherein said lectures and associated educational materials being distributed in a broadcasting manner are received by said subscriber terminals and stored in an internal memory, and read out of said memory and reproduced for learning by said subscribers when said subscribers use said lectures and associated educational materials.

10. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said satellite communication correspondence school being connected to said lecturer terminals for lecturer's use via said satellite communication earth station and communication satellite, and via said communication network on the ground, whereby a real time lecture function is provided for giving a seminar in which said lecturers and subscribers simultaneously use a broadcasting function of said communication satellite, a return communication function using either said communication network on the ground or said communication satellite, and a communication function for lectures for accessing to a mailbox equipped in said satellite communication correspondence school and to e-mails.

11. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said subscriber terminals being used for a direct satellite broadcast (DSB) receiver and a very small aperture terminal (VSAT), whereby said satellite communication correspondence school provides said subscribers with said lectures and associated educational materials in a broadcasting manner.

12. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein if said communication satellite radiates global beams and spot beams, said satellite communication earth station being arranged within said global beams, and said subscriber terminals being arranged within said spot beams, whereby said satellite communication correspondence school provides said subscribers with said lectures and their associated educational materials in a broadcasting manner.

13. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein if said communication satellite radiates a plurality of spot beams, said satellite communication earth station being arranged within part of said spot beams, and said subscriber terminals being arranged within remaining spot beams within which no earth station is arranged, whereby said satellite communication correspondence school provides said subscribers with said lectures and their associated educational materials in a broadcasting manner.

14. An education system using satellite communications comprising a satellite communication correspondence school which plays a central role in an education service provided by said education system, and subscriber terminals connected to said satellite communication correspondence school via a communication satellite and a satellite communication earth station, said subscriber terminals being used by subscribers who take part in said education service to participate in lectures given by lecturers, wherein said satellite communication correspondence school being connected to said subscriber terminals through a communication network on the ground including the Internet, and wherein said subscriber terminals being realized by portable satellite communication terminals, whereby said satellite communication correspondence school provides said subscribers with said lectures and associated educational materials in a broadcasting manner.
